(19) United States
(12) Patent Application Publication
(10) Pub. No.: US 2013/0009483 A1
(43) Pub. Date: Jan. 10, 2013

(54) POWER GENERATOR MODULE CONNECTIVITY CONTROL

(76) Inventors: Keith W. Kawate, Attleboro Falls, MA (US); Christopher E. Pinette, Seekonk, MA (US); John R. Wezowicz, Taunton, MA (US); Thomas R. Maher, Rehoboth, MA (US); Michael B. Rose, Marlon, MA (US)

(21) Appl. No.: 13/482,911

(22) Filed: May 29, 2012

Related U.S. Application Data
(60) Provisional application No. 61/491,359, filed on May 31, 2011.
(60) Provisional application No. 61/579,437, filed on Dec. 22, 2011.

(51) Int. Cl. H02J 1/06

(52) U.S. Cl. 307/77

(57) ABSTRACT

A remote resource can be configured to control connectivity of the power generator modules in a string. For example, a respective power generator module can include a current sense circuit that monitors for presence of communication signal. The power generator module can monitor for a presence of a remotely generated control signal over power line that is used by the respective power generator module to convey power to the external load. If the control signal is present on the power line, as generated by the remote resource, the control circuit in the respective power generator module activates the switch to an ON state such that respective activated power generator module is connected in series with the other activated power generator modules. If no keep-alive control signal is detected within a timeout period, the controller deactivates the respective power generator module.

### RELATED APPLICATIONS

This application is related to and claims the benefit of earlier filed U.S. Provisional Patent Application Ser. No. 61/491,359 entitled “Photovoltaic Module Latch,” filed on May 31, 2011, the entire teachings of which are incorporated herein by this reference.

This application is also related to and claims the benefit of earlier filed U.S. Provisional Patent Application Ser. No. 61/579,437 entitled “Photovoltaic Module Level Disconnect,” filed on Dec. 22, 2011, the entire teachings of which are incorporated herein by this reference.

### BACKGROUND

Conventional PhotoVoltaic (PV) power systems produce power for many types of applications. For example, in one conventional application, the power generated by a solar array can be used to charge batteries that make power available during non-daylight hours.

FIG. 1 is a diagram illustrating a typical PV array 105 (e.g., multiple PV devices 135 connected in series) driving inverter or charger load 110. Each of the photovoltaic modules 135 can generate up to 10 Amperes at 50 volts DC.

As shown, PV modules 135 can be connected in series to elevate a produced DC voltage. In certain cases, the voltage produced by a string of PV modules may be on the order of more than 1000 Vdc if the string includes a sufficient number of modules connected in series.

The parallel strings of PV modules can increase the total DC current to more than 200 Amperes. Thus, remote disconnection and reconnection of the power provided by photovoltaic power systems may be desirable as a safety feature to enable manual or automatic system shutdown, typically nearer the load.

In certain cases, faults in a string can cause excessive reverse currents from other strings. Therefore each string may need its own fuse or breaker.

Note that FIG. 1 also includes a capacitor 114, representing the input capacitance typically found in load 110 such as an inverter or charger. The fuse 115 (or breaker) between the negative terminal (−) of the PV module array 105 and earth ground 116 helps extinguish current between the PV array 105 and earth ground 116. Lightning arrestor device 118 helps protect the PV array 105 against damage from lightning strikes by shunting excessive voltage to earth ground 116.

A power system can include a DC switch 120, providing the capability of disconnecting the load (e.g., inverter/charger 110) from the PV array 105. However, disconnection and reconnection of the photovoltaic power near the load 110 does not ensure that both the current and the voltage levels are safe between the PV module system and the DC switch 120, thereby representing a potential danger to emergency personnel such as firemen and PV system maintenance personnel.

### BRIEF DESCRIPTION

In contrast to conventional applications, embodiments herein enable a user to uniquely control connectivity in a power system. For example, each power generator module (e.g., power supply, photovoltaic power generating resource, etc.) in a corresponding string of multiple power generator modules connected in series includes respective control circuitry. The control circuitry can include a controller that drives a switch in the power generator module. The respective power generator module includes output terminals, across which a voltage is produced when a power generator resource (e.g., a power source such as multiple PV cells) in the power generator module is exposed to sunlight. The power generator modules can be selectively activated in the series connection to produce a voltage that is used to power an external load such as an inverter, optimizer, charger, etc.

In accordance with further embodiments, a remote resource can be configured to control connectivity of the power generator modules in a string. For example, a respective power generator module can include a current sense circuit that monitors for presence of communication signal from a control signal generator. More specifically, the respective PV module can monitor for a presence of a remotely generated keep-alive (i.e., activation signal) signal transmitted over power line that is used by the respective power generator module to convey power to the external load. If the keep-alive signal is present on the power line, as generated by the remote resource, the control circuit in the respective power generator module activates the switch to an ON state (or continues to activate the respective PV module) such that respective activated power generator module is connected in series with the other one or more activated power generator modules in the series string. In one embodiment, if no keep-alive signal is detected within a timeout period, the respective power generator module deactivates the respective power generator module.

Each power generator module in a string can include a bypass capacitor substantially disposed across its output terminals. The control signal to control one or more power generator modules in the string can be an AC type signal (e.g., sine wave, quasi-sine wave, saw-tooth pulses, square pulses, etc.) transmitted on the power line to each of the power generator modules to turn each of the power generator modules in the string to an ON state. The bypass capacitor in the power generator module provides a low-impedance path to enable conveyance of the communication signal to other power generator modules downstream in the series connection because the capacitors pass the AC control signal but block DC signals. Thus, each of multiple power generator modules in a respective string can receive the communication signal.

Embodiments herein further include diode (a.k.a., circulating diode, free-wheeling diode, module-level bypass diode) disposed across terminals of the power generator module to enable use of a lower voltage FET (Field Effect Transistor) or relay for the series control switch (e.g., low cost switch) disposed in each power generator module. In one example embodiment, the inherent diode in the field effect transistor can also serve as a bypass diode, which conducts string current when the series switch is disconnected, to enable use of a lower voltage diode across terminals of the power generator module. Over-temperature and/or under-voltage protection as implemented herein also can reduce excessive power dissipation resulting from higher FET on-resistance or relay contact resistance. For example, in one embodiment, the under-voltage protection in a respective power generator module provides the additional system benefit that when there is a transient condition such as an arc fault or ground fault that shorts the array or string power lines together, the under-voltage protection causes each respective switch in each power generator module of the strings to be turned OFF, thus reducing the available power to feed the transient condition.

In accordance with further embodiments, switching noise generated by an external load (e.g., power converter, charger, etc.) can be reduced or eliminated in conjunction with the removal of a power-line signal, since the noise can be inadvertently interpreted as a simple continuous “keep-alive” signal. A simple continuous “keep-alive” signal generator as discussed herein facilitates a lower cost control circuit in each power generator module that does not need to demodulate or decode the signal.

In further embodiments, the module level control apparatus provides a means to disconnect each respective power source from the string or power generator module by turning off the power-line signal generator in response to manual or automatic activation of a remote disconnect switch by emergency or maintenance personnel or in response to automatic activation by an arc fault or ground fault detector or through coordination with the control of a load (inverter, optimizer, charger). In addition, the keep-alive control signal can be terminated upon loss of power to the keep-alive signal generator, opening of PV power-line connections, and/or shorting between power lines.

These and other embodiment variations are discussed in more detail below.

As mentioned above, note that embodiments herein can include a configuration of one or more computerized devices, hardware processor devices, assemblers, or the like to carry out and/or support any or all of the method operations disclosed herein. In other words, one or more computerized devices, processors, digital signal processors, assemblers, etc., can be programmed and/or configured to perform the method as discussed herein.

Additionally, although each of the different features, techniques, configurations, etc., herein may be discussed in different places of this disclosure, it is intended that each of the concepts can be executed independently of each other or in combination with each other. Accordingly, the one or more present inventions, embodiments, etc., as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

FIG. 1 is an example diagram of a PV array according to conventional techniques.

FIG. 2 is an example diagram illustrating a power system including multiple power generator modules in series according to embodiments herein.

FIG. 3 is an example diagram illustrating a power generator module according to embodiments herein.

FIGS. 4-6 are example diagrams illustrating locations where a power system can experience transients according to embodiments herein.

FIG. 7 is an example diagram illustrating keep-alive circuit according to embodiments herein.

FIG. 8 is an example diagram illustrating a power generator module according to embodiments herein.

FIG. 9 is an example diagram illustrating additional details of a series switch and control circuit according to embodiments herein.

FIG. 10 is an example diagram illustrating an example of power generator module current vs. power generator module voltage for multiple levels of uniform irradiance according to embodiments herein.

FIGS. 11-14 are example diagrams illustrating latched type of power generator module according to embodiments herein.

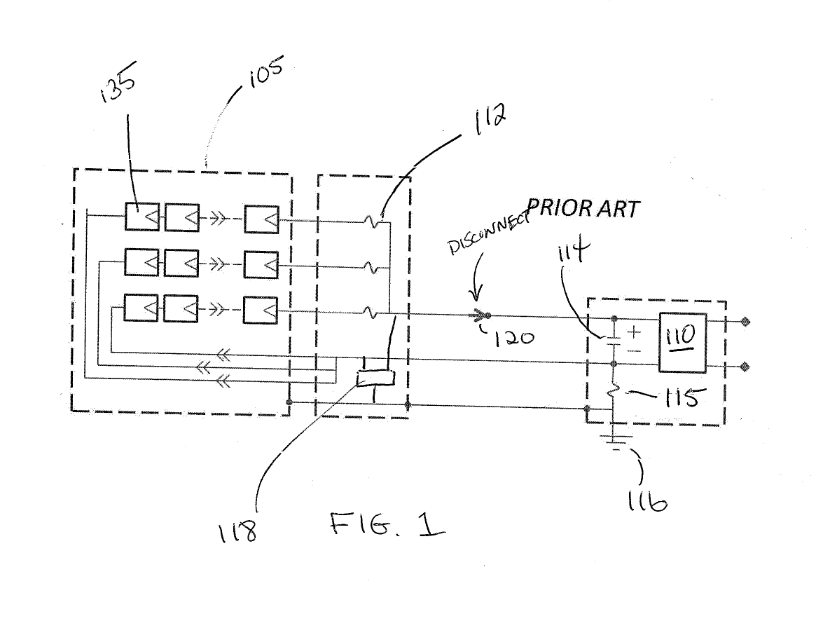

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

As discussed above, embodiments herein deviate with respect to conventional power generation systems.

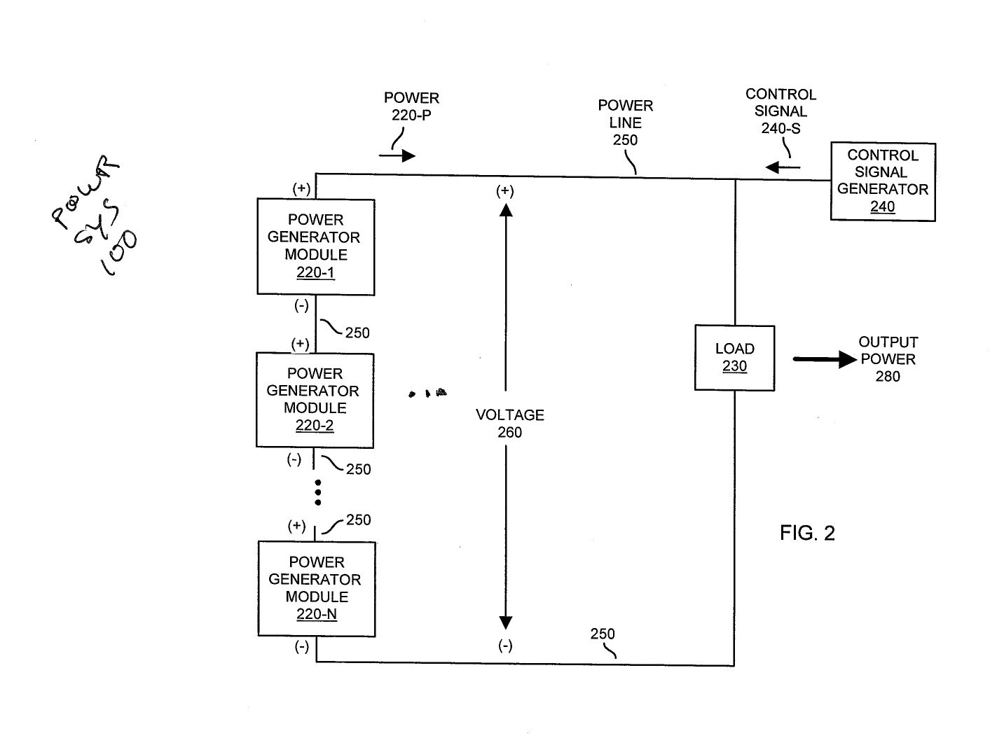

More specifically, FIG. 2 is an example diagram illustrating control of a series connection of selectively activated power generator modules according to embodiments herein.

As shown, power system 100 includes at least one string of power generator modules 220 (e.g., power generator module 220-1, power generator module 220-2, . . . , power generator module 220-N), control signal generator 240, and load 230.

Note that the power system 100 can include any suitable number of strings of power generator modules 220 in parallel to produce voltage 260.

As its name suggests, control signal generator 240 generates one or more control signals 240-S to control the power generator modules 220.

More specifically, in one embodiment, control signal generator 240 produces control signal 240-S to control functionality associated with the power generator modules 220. For example, the control signal generator 240 transmits control signal 240-S over power line 250 to the power generator modules 220. Each of the power generator modules 220 in the string receives the control signal 240-S. The power generator modules 220 receive the control signal 240-S and perform a respective function in accordance with the received control signal 240-S.

In one embodiment, the control signal generator 240 generates one or more control signals 240-S to activate each of the power generator modules 220 in a string. In one embodiment, the series connection of activated power generator modules 220 produce voltage 260 used to power load 230.

Each of the power generator modules 220 in a string includes an anode (+) and cathode (−) serially connected in the power line 250 as shown. When activated, each of the power generator modules 220 generates a respective voltage across a respective anode terminal (+) and cathode terminal (−). Because the string power generator modules 220 are connected in series as shown when activated, assuming no faults and that each power generator module generates a voltage, the output voltage 260 produced by the string of power generator modules 220 is a summation of the individual output voltages produced by each power generator module. A string of power generator modules produces string current at the output voltage 260.

Thus, in accordance with the control signal generator 240, the string of power generator modules 220 can be controllably connected in series to convey generated power 220-P over a respective power line 250 through the power generator modules to a load 230.

Note that the control signal generator 240 can discontinue producing control signal 240-S (which may include one or more control signals) or send a communication to the power generator modules 220 to deactivate them. In such an instance, the power generator modules 220 turn OFF and no longer produce voltage 260 that is used to drive load 230.

By way of a non-limiting example, the voltage 260 produced by a string of activated power generator modules 220 can be a substantially DC voltage.

The control signal 240-S can be any suitable type of signal. For example, in one embodiment, the control signal 240-S can be an AC signal that is superimposed on the voltage 260. In such an instance, the power generator modules 220 use the AC signal (e.g., control signal 240-S) as a basis to determine whether the respective power generator module should be activated to produce an output voltage across its terminals.

In this example embodiment, load 230 can be any suitable type of resource (e.g., inverter, charger, etc.) that converts, conditions, etc., power 220-P produced by power generator modules 220 into output power 280.

The output power 280 can be used to power loads that, in turn, consume the output power 280 to perform a desired function. The load 230 can be configured to convert the voltage 260 into a 120-volt AC signal.

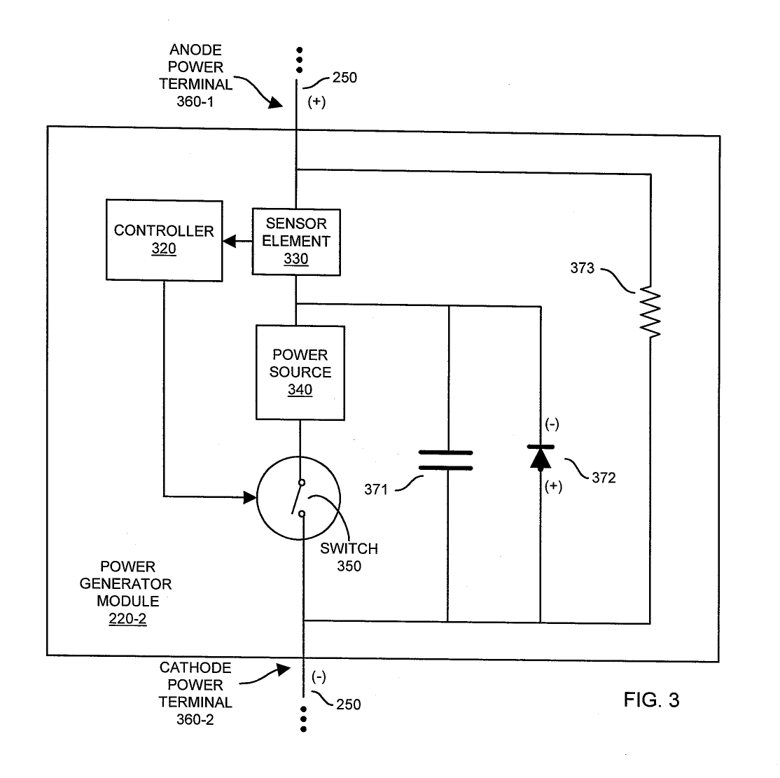

FIG. 3 is an example diagram illustrating more specific functionality associated with one or more of the power generator modules according to embodiments herein. Note that each of the power generator modules 220 can operate in a similar manner as discussed below.

As discussed herein, activating the switch 350 to an ON state means driving the switch 350 with an appropriate signal that produces a low impedance path between the respective power source 340 and the respective cathode power terminal 360-2. In this instance, the switch 350 is closed.

Deactivating the switch 350 to an OFF state means driving the switch 350 with an appropriate signal that produces a high impedance path between power source 340 and the cathode power terminal 360-2. In this instance, the switch 350 is open.

As shown, power generator module 220-2 includes a controller 320, sensor element 330, power source 340, switch 350, capacitor 371, bypass diode 372, and bleed resistor 373.

The power source 340 can be any suitable type of resource such a PV panel including multiple solar cells that collectively generate an output current at a respective DC voltage. The PV panel can be configured to convert solar energy (i.e., optical energy) received from the sun into electrical energy. In one example embodiment, the power generator modules 220 are so-called PhotoVoltaic (PV) type modules that convert solar energy to electrical energy.

The switches 350 disposed in each of the power generator modules 220 can be any suitable type of resource such as field effect transistor, electro-mechanical relay, etc.

In one embodiment, the controller 320 monitors a presence of control signal 240-S received over the power line 250 as generated by a remotely located control signal generator 240. The controller 320 detects such a condition by receiving input from sensor element 330. Based on the input from the sensor element 330, the controller 320 receives communications from the control signal generator 240 indicating how to control the power generator module 220-2.

Thus, based on the control signal 240-S received by the controller 320, the controller 320 controls a state of the switch 350. For example, the switch 350 selectively activates the respective power generator module 220-2 in the series connection of power generator modules 220.

More specifically, in one non-limiting example embodiment, if the sensor element 330 receives a control signal 240-S indicating to activate the respective switch 350, the controller 320 receives input from the sensor element 330 and generates an internal control signal to turn switch 350 to an ON state in accordance with the detected control signal 240-S. In one example embodiment, if the sensor element 330 does not detect a presence of the control signal 240-S indicating to activate the respective switch 350, after a timeout period since receipt of a previous activation control signal received from the control signal generator 240, the controller 320 initiates deactivation of switch 350 to an OFF state.

Thus, in accordance with one example embodiment, the control signal 240-S can be a keep-alive signal. As long as the power generator module 220-2 detects periodically or continuously the keep-alive signal as generated by the control signal generator 240, the controller 320 activates switch to an ON state. The controller 320 deactivates switch 350 to an OFF state after failing to detect presence of control signal 240-S.

Note that the sensor element 330 can be any suitable type of resource such as a low-impedance sensing element. For example, the low-impedance element can be disposed serially in an electrical path extending between the anode power terminal 360-1 and the power source 340, enabling current to pass along a low impedance path of the power line, having little impact on the output voltage produced by the power source 340.

The sensor element 330 can be any suitable type of resource such as a current or voltage sensor device to detect a presence of the control signal 240-S.

In one non-limiting example embodiment, the sensor element 330 is a transformer device in which a first winding of the transformer is connected in series between the anode power terminal 360-1 and the power source 340. The controller 320 monitors a second winding of the transformer. In such an instance, the second winding of the transformer transmits the AC signal produced by the control signal generator 240 to the controller 320. The controller 320 can process the signal to determine whether or not the received signal is a valid keep-alive signal or noise. The power source 340 can produce a DC current or voltage. The DC current through the first winding of the transformer does not produce a voltage across the second winding. Thus, the sensor element 330 can be an AC sensing element that allows DC elements of a power signal to be conveyed to the load 230 over power line 250.

Note that as an alternative to being serially disposed in the path, the sensor element 330 can be a capacitor. The anode power terminal 360-1 can be coupled directly to the power source 340. One end of the sensor element 330 can be coupled to the anode power terminal node 360-1, the other end of the capacitor can be coupled to sensing circuit in the controller 320 that detects presence (or absence) of an at least occasional AC signal produced by the control signal generator 240. Thus, the sensor element 330 can provide voltage sensing capability to detect presence of a control signal 240-S.

Inclusion of the bypass capacitor 371 in each of the power generator modules in a series or string ensure that each power generator module in the string will receive at least a portion of the control signal 240-S generated by the control signal generator 240. For example, the respective capacitor 371 in each respective power generator module of the string forms part of a series connection of multiple power generator modules 220. The capacitors 371 in the power generator modules act as a voltage divider (and allow passing of AC current through the string) such that each of the power generator modules 220 receives at least a portion of the control signal 240-S at substantially the same time. Thus, each of the power generator modules 220 can include a respective capacitor 371 disposed across output terminals (e.g., terminal 360-1 and 360-2) of the respective power generator module 220 to convey the control signal 240-S on the power line 250.

Assuming that the power generator module 220 in the string are initially all disabled or deactivated, transmitting the control signal 240-S over the power line 250 causes each of the controllers 320 to initiate substantially simultaneous activation (e.g., turning ON respective switches 350) of the power generator modules 220 to produce output voltage 260. In other words, the control signal 240, or absence thereof, affords simultaneous control of the power generator module 220-2 because each of the power generator modules receives such a signal at substantially the same time.

Thus, the control signal generator 240 can be configured to generate a control signal 240-S. The control signal generator 240 transmits the control signal 240-S over power line 250 to activate each of multiple power generator modules 220 in a series connection. The load 230 receives power over the power line 250 from the activated power generator modules 220 connected in series. As mentioned, the control signal can be an AC signal. The power received over the power line 250 can be a substantially DC voltage and/or DC current produced by the series connection of multiple simultaneously activated power generator modules 220.

In one embodiment, as mentioned, the control signal generator 240 can be further configured to discontinue transmission of the control signal 240-S over the power line 250 in order to deactivate each respective power generator module in the series connection of multiple power generator modules 220.

As previously discussed, the sensor element 320 can be configured to detect current. The control signal generator 240 generates the control signal 240-S as pulses of current. As previously discussed, the controller 320 in each respective power generator module 220 receives the signal and controls switch 350 accordingly. In accordance with further embodiments, the controller 320 compares the input from sensor element 330 to one or more threshold values (e.g., a first threshold value, a second threshold value, etc.) The controller 320 activates the switch 350 to an ON state responsive to detecting that the current sensed by the sensor element 330 is greater than a first threshold value. The controller 320 deactivates the switch 350 to an OFF state responsive to detecting that the current sensed by the sensor element 330 is less than a second threshold value. Depending on the embodiment, the first threshold value can be higher in magnitude than the second threshold value. Alternatively, the first threshold value and the second threshold value can be substantially equal.

The power line 250 can be susceptible to noise. For example, the load 230 can perform switching to convert the voltage 260 into output power 280. In such embodiments, the operations of the control signal generator 240 and the load can be controlled and/or synchronized such that the noise imparted on the power line 250 does not impact control of the power generator modules 220.

As a more specific example, the control signal generator 240 (i.e., remote signal generator) can be configured to produce the control signal 240-S as a keep-alive signal as discussed above. The control signal generator 240 can also provide a signal to shut off the load and thereby shut off the switching noise associated with the load 230 that may be interpreted by the controller 320 in a respective power generator module as a keep-alive signal.

The diode 372 in each respective power generator module 220 enables a respective power generator module to operate in a bias mode if the respective switch 350 is not activated. The bypass mode (e.g., during deactivation of the switch 350) enables a respective power generator module 220 to pass current and/or voltage signals even if the power generator module is in an OFF state.

For example, assume for some reason that the controller 320 in power generator module 220-2 fails to turn ON switch 350 in response to receiving the control signal 240-S, but that the other upstream and downstream power generator modules in the series become activated based on receiving the control signal 240-S. In such an instance, because switch 350 in the power generator module 220-2 is deactivated (OFF), the power generator module 220-2 does not contribute to creating the output voltage 260. However, each of the other activated power generator modules do contribute to generation of the output voltage 260 due to the series connectivity. The magnitude of the output voltage 260 is lower than it would otherwise be if the power generator module 220-2 were activated. That is, by way of a non-limiting example, if each active power generator module contributes X volts, and only (N−1) possible power generator modules in a string are activated, the output voltage 260 or string is substantially (N−1)X. If all power generator modules were active including power generator module 220-2, the output voltage 260 would be a magnitude of substantially (N)X.

In one embodiment, when the control signal generator 240 discontinues generating control signal 240-S, the controller 320 can set the respective switch 350 to an OFF state to operate the respective power generator module 220-2 in a bypass mode. In other words, a respective power generator module can operate in a bypass mode in the absence of detecting presence of the control signal 240-S.

In accordance with yet further embodiments, note that the diode 372 disposed across output terminals 360-1 and 360-2 of the respective power generator module 220-2 protect the switch from being damaged by an over voltage condition, thereby limiting bypass diode power dissipation in the switch 350. Accordingly, the switch 350 is less susceptible to being damaged.

Additionally, the diode 372 disposed across terminals of the power generator module 220 enables use of a respective switch 350 such as a lower voltage FET (Field Effect Transistor) or relay for the series control switch (e.g., low cost switch) disposed in each power generator module. When switch 350 is a field effect transistor, the inherent diode in the field effect transistor can also serve as a bypass diode. That is, the inherent diode in the switch 350 can conduct string current when the series switch is disconnected, thus facilitating over-voltage protection of the diode 372.

As further discussed below, the over-temperature and under-voltage protection (e.g., the controller 320 can monitor a regulated voltage produced by power source 340 and shut the switch 350 OFF if the generated voltage to power the control circuit or related circuitry is too low) also can reduce excessive power dissipation resulting from higher FET on-resistance or relay contact resistance. This under-voltage protection provides the additional system benefit that when there is a transient such as an arc fault or ground fault that shorts the array or string power lines together, the under-voltage protection opens each respective switch 350 in each power generator module of the parallel strings, thus reducing the available power to feed the arc fault or ground fault.

Thus, further embodiments herein include a power generator module disposed in a series connection of multiple power generator modules. Each respective power generator module in a series connection of power generator modules can include: an anode power terminal 360-1; a cathode power terminal 360-2; and a diode 372 (i.e., a diode device). An anode (+) end of the diode 372 is coupled via a low impedance electrical path to the cathode power terminal 360-2 of the respective power generator module.

As mentioned, the switch 350 is disposed in series with a power source 340 that generates respective power. The switch 350 controls application of the power produced by the power source 340 across the anode power terminal 360-1 and the cathode power terminal 360-2 of the respective power generator module 220-2.

The switch 350 can be a field effect transistor having an inherent diode; a forward bias of the inherent diode supports a current flow from the anode power terminal 360-1 to the cathode power terminal 360-2 through the power source 340.

As shown, a combination of the switch 350 in series with the power resource 340 can be disposed substantially in parallel with the diode 372. Sensor element 330 in each power generator module monitor presence of a communication signal received over power line 250 to which the anode power terminal 360-1 and cathode power terminal 360-2 are connected in a series formation. As previously discussed, the controller 320 (i.e., control circuitry) controls a state of the switch 350 depending on the control signal (i.e., communication signal).

Note that the control signal 240-S as produced by the control signal generator 240 need not be a keep-alive type signal. Instead, the control signals produced by the control signal generator 240 can be encoded such that a power generator module receiving the control signal performs a respective function. For example, one type of control signal (e.g., a first encoded communication) can be transmitted to the power generator module to activate respective switch 350. Another type of control signal (e.g., a second encoded communication) can be transmitted to deactivate switch 350.

Yet further embodiments can include targeting the commands to different power generator modules. For example, each command can be encoded with a target address value indicating whether the command is directed to a string of power generator modules or a specific power generator module in the string. The controller 320 can include appropriate power generator capability to decode the received signal to determine whether it was addressed to the receiving power generator module. If so, the controller 320 can decode the command intended by the communication received from the control signal generator 240 to determine what function to perform.

Accordingly, the power generator modules 220 can be controlled via generation of different types of commands. The commands generated by the control signal generator 240 can be specifically targeted to the different power generator modules.

In a reverse direction, further embodiments herein can include communicating from the respective power generator module 220 over power line 250 to the control signal generator (or other suitable message processing resource). Each power generator module 220 can be assigned a unique address. The power generator module can include the address of the power generator module in the message such that the control signal generator receiving the message can identify which of the power generator modules 220 generated the message. A message from the power generator module can include status information such as the health of the power source 340 and its ability to generate power, a voltage produced by the power source in the power generator module, etc. The power generator modules 220 can transmit messages to the control signal generator as an AC type signal. The control signal generator 240 can include appropriate circuitry to monitor a presence of messages received from the power generator modules over the power line.

In accordance with yet further embodiments, the power generator modules can be configured to communicate with each other based on including a destination address (e.g., an address of the power generator module to which the communication is directed) in the message as well as source address (e.g., an address of the power generator module transmitting the communication).

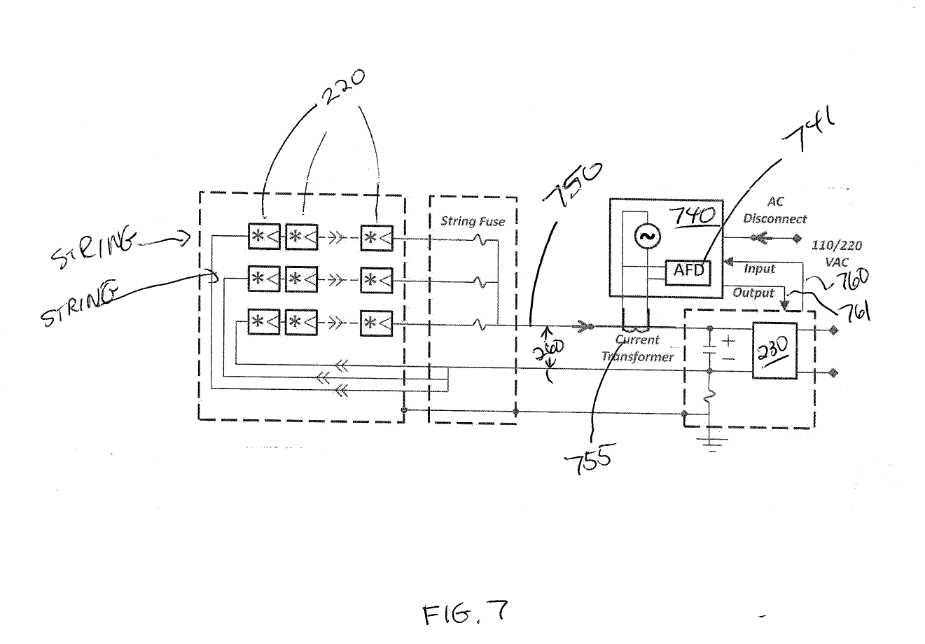

According to further embodiments herein, FIG. 7 shows parallel strings of PV modules each with a switch and control circuit. More specifically, multiple strings of PV modules including respective switches can be connected in parallel to produce voltage 260.

In one specific embodiment, a “keep-alive” signal generator 740 is coupled to the power lines 750 via a current transformer 755, along with an optional arc fault detector 741 (AFD) and I/O to a load 230 such as an inverter, optimizer, charger, etc.

Note that the current and/or voltage superimposed on power lines 750 can be sensed by suitable technology, including a shunt, hall-effect sensor, flux-gate magnetic sensor, etc.

The “keep-alive” signal generator 740 can be a conventional narrow-band, single-direction power-line communications generator at a single frequency, e.g., typically between 9 kHz and 148 kHz, or as otherwise allowed by international standards. This signal produced by the generator 740 can be amplitude-modulated, frequency-modulated, or phase-modulated, encoded, etc., for improved noise rejection. However, a module-level-disconnect (MLD) circuit would also be more complex and costly resulting from the required demodulation or decoding functions.

FIG. 7 also shows an input 760 from the load 230 as a means of PV module-level-disconnect (MLD) control. An output 761 is also provided to shut off or reduce switching noise from the load 230. The switching noise may otherwise generate a false “keep-alive” signal, when it is desired to deactivate the power generator modules as previously discussed. Also, an output signal from the load 230 to controller 740 can be used to terminate the “keep-alive” signal.

While this figure shows the AFD 741 located near the load 230, the AFD 741 can be located at the string level near or within the combiner box. Also, the current transformer 755 for signal injection can also be used for AFD 741 arc signal detection.

Note that while the current transformer 755 is shown in series with the positive end of power line 750, the transformer 755 can also be in series with the negative end of power line 750 or can be capacitor-coupled between the positive and negative power lines 750. In the latter case, inductive chokes can be used in the positive and/or negative power lines to reduce the shorting effects of the input capacitance to the load 230.

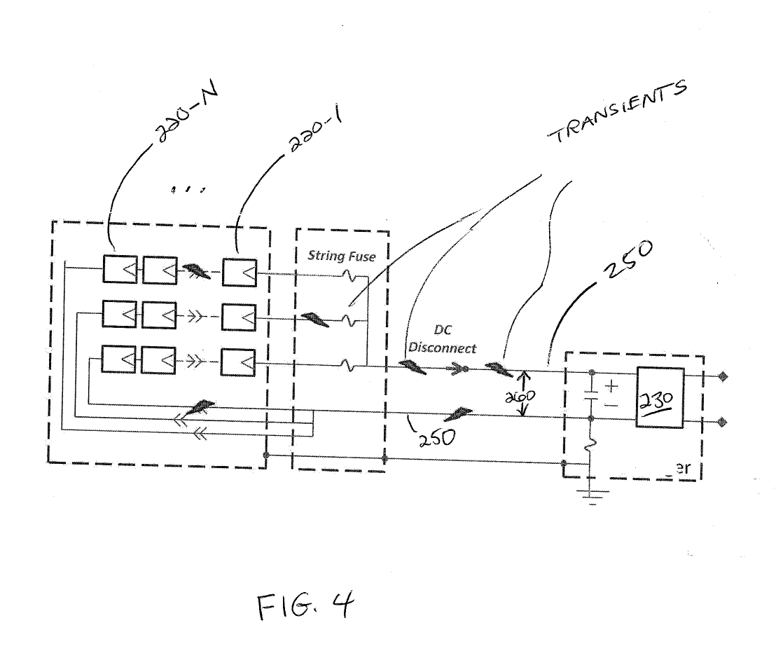

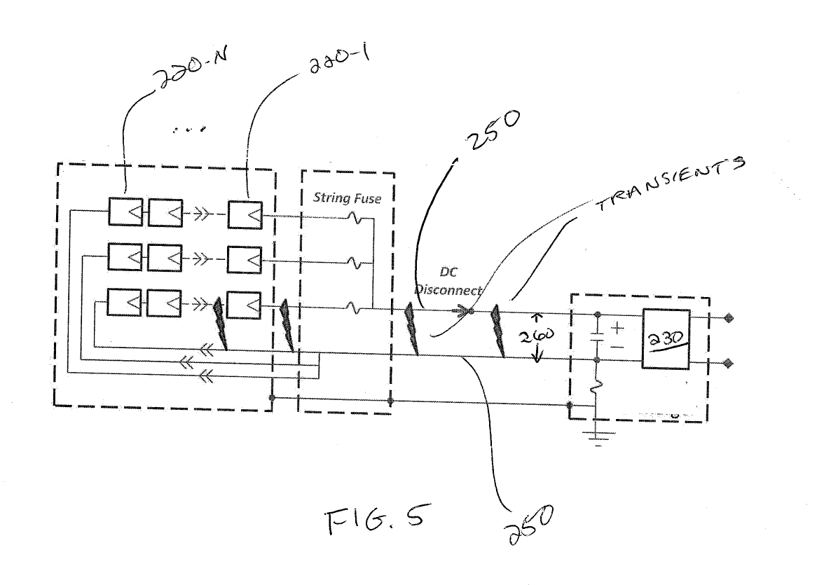

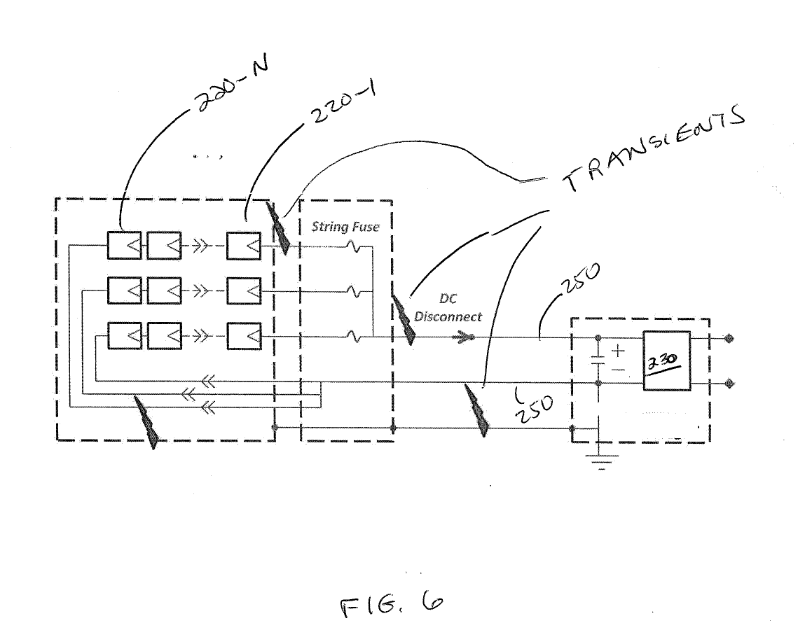

If the AFD 741 detects a series or parallel transient as depicted in FIGS. 4, 5, and 6, the AFD can disconnect each module remotely by shutting off the keep-alive signal generator 740. The AFD 741 can also send an output to the load 230 to shut off switching at its input, thus removing a potential source of a false keep-alive signal.

The series connection of power generator modules can be disconnected by open string or array connections, fuse or breaker opening in a string or array, and shorts between the power lines.

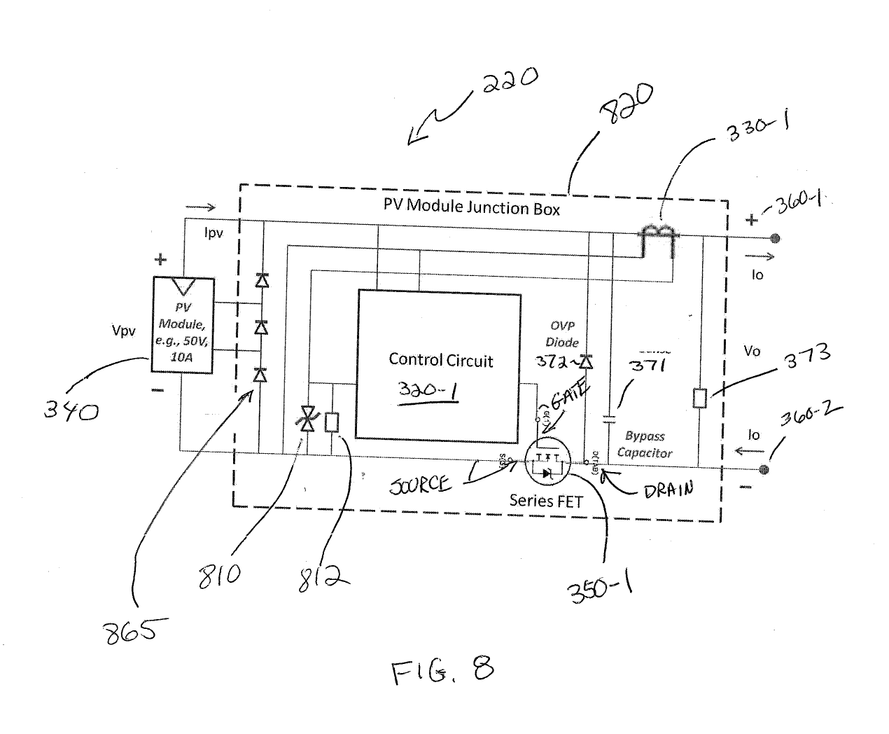

FIG. 8 shows the series switch and control circuit attached to each respective PV module according to embodiments herein.

In this example embodiment, the series switch 350-1 and power source 340 form an output across terminals 360-1 and 360-2 that supplies output current “Io” and output voltage “Vo”. The control circuit 320-1 includes inputs from a current sensing element 330-1 that monitors for presence of the “keep-alive” signal. An over-voltage clamp device 810 prevents damage to the control circuit 320-1 and a load resistor 812 converts the primary winding current from current sensing element 330-1 to a secondary voltage. As mentioned, the field-effect transistor (FET) 350-1 can be replaced by any suitable resource such as an electromechanical relay with the relay coil replacing the FET gate and the relay contacts replacing the FET drain and source.

Several well-known problems exist with the use of physical relays. Contact life is limited by contact erosion caused by switching, especially at higher voltage and current. The power dissipation resulting from the contacts can increase over time if contamination increases the contact resistance. The contacts are subject to a failure-to-close if an insulating particle or film gets between the contacts, and a failure-to-open if the contacts weld together. The coil dissipates power when energized and can be a substantial fraction of the power dissipated when the contacts are closed, thereby increasing the temperature of the apparatus and lowering the energy efficiency of the PV system. In addition, the size and cost of such relays can exceed a solid-state relay and also the electrical and mechanical life can be much lower than a solid state switch.

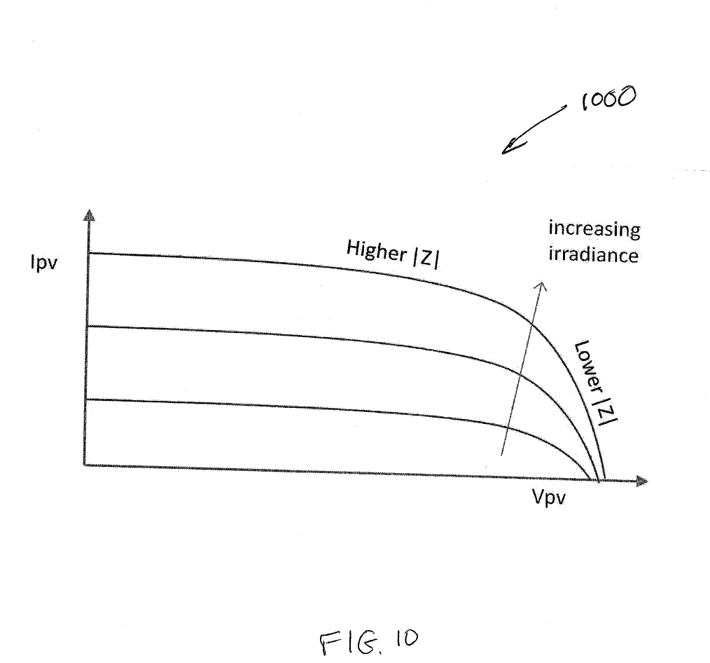

Other components can include a bypass capacitor 371 to conduct the keep-alive signal through a PV string, since as shown in FIG. 10, the absolute or shunt impedance of a respective power generator module can attenuate the signal, and the FET 350-1 in the off state will also attenuate the signal. An over-voltage protection (OVP) diode 372 enables use of a lower-voltage FET 350-1. Bleed resistor 373 discharges power-line voltage left on the capacitor 371.

The OVP diode 372 works in conjunction with the PV module to limit the maximum voltage across the FET 350-1, and the FET 350-1 substrate diode (i.e., inherent diode) works in conjunction with the PV module to limit the reverse voltage across the OVP diode 372. In this manner, the module-level-disconnect (MLD) FET 350-1 and OVP diode 372 only need to withstand the continuous voltages associated with each power source 340 (i.e., PV module), not the much higher string and array voltage (e.g., output voltage 260) that would increase the FET 350-1 and OVP diode 372 cost. The OVP diode 372 can also be an “active” diode having lower voltage drop and therefore lower power dissipation when forward-biased. An active diode can be a FET-based device having lower voltage drop than a forward-biased FET substrate diode (e.g., inherent diode in FET 350-1).

Also shown in FIG. 8 is a PV power module (i.e., power source 340) and multiple bypass diodes 865. The bypass diodes 865 serve the function of allowing a section (e.g., multiple PV solar cells) of the power source 340 to be bypassed should the section's current resulting from irradiance fall sufficiently below other modules in the string. Power dissipation in the PV module junction box 820 will increase as more of these bypass diodes 865 are forward-biased.

When the temperature of the junction box or internal components becomes too high, the series FET 350-1 can be configured to shut OFF, resulting in the respective power source 340 from being part of a series connection of power generator modules. In other words, if the temperature of junction box 820 or any portion thereof is detected to be above a threshold value, the control circuit 320-1 can be configured to shut OFF the switch 350-1. Thus, the control circuit 320-1 can override a command from the control signal generator 240 to deactivate the switch 350-1 to an OFF state. As mentioned, even if a single power generator module 220 operates in a bypass mode, other power generator modules in a series can be activated to generate a respective output voltage 260, albeit a lower voltage. Shutting OFF the respective switch 350-1 in a power generator module lowers its power dissipation and helps to prevent damage due to excessive heat.

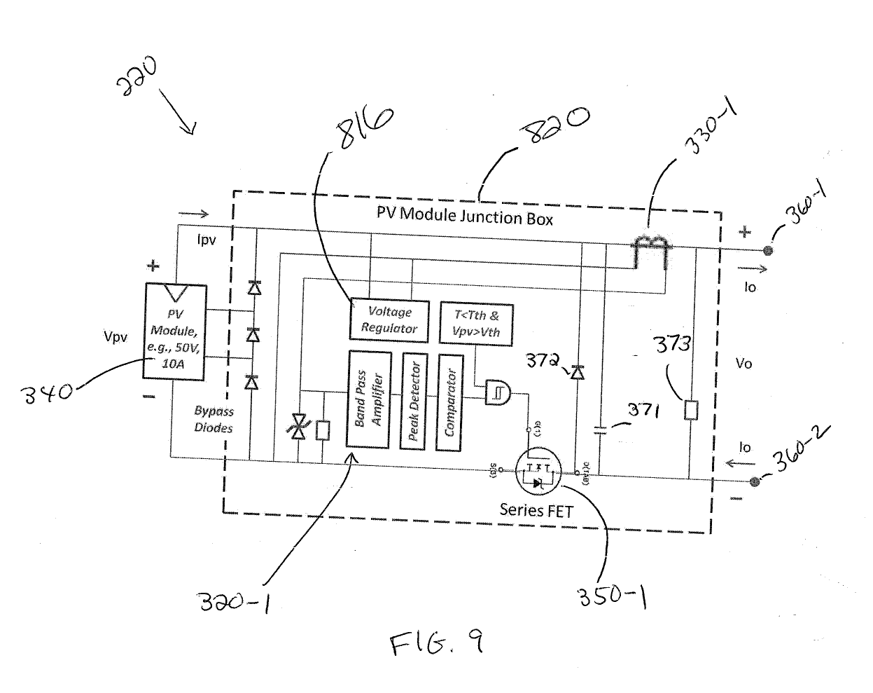

FIG. 9 shows the series switch and control circuit attached to each PV module. The control circuit 320-1 includes inputs from current sensor element 330-1. The control circuit 320-1 can include any of one or more components such as a band pass filter, amplifiers, peak detectors, comparators, voltage regulators, etc.

In one embodiment, the control circuit 320-1 has an associated band pass filter and time constant (such as between 1 milliseconds and 100 milliseconds) for controlling changes in switch 350-1 open and close state to reduce the susceptibility of false turn ONs due to noise.

As shown, the respective power generator module can include a voltage regulator 816. The voltage regulator 816 can receive power from power source 340. An output of the voltage regulator 816 powers control circuit 320-1 and other related circuitry in the power generator module.

In one embodiment, when the keep-alive signal received from the control signal generator 240 falls below a threshold value, the control circuit 320-1 controls the series FET 350-1 to an OFF state to disconnect the power source 340 (such as a PV module) from the string.

As previously discussed, even if the power generator module receives a command to turn ON switch 350-1, another control circuit block in the respective power generator module can be configured to disconnect the power source 340 from the string if the temperature of a monitored portion of the junction box 820 such as the bypass diodes, control circuit 320-1, etc., exceeds a safe operating temperature threshold Tth and the PV module voltage declines below a voltage threshold Vth such that the regulated voltage does not provide sufficient voltage for the control circuit 320-1 to operate and for the FET 350-1 to turn-on with low switch resistance.

For example, the control circuit 320-1 can be configured to turn the switch 350-1 OFF if the switch 350-1 cannot be turned ON using a sufficiently high gate voltage. If the gate voltage is too low, the ON-resistance of the switch 350-1 will be high, resulting in excessive heat dissipation in the switch 350-1 causing damage. When the FET switch 350-1 turns OFF as controlled by control circuit 320-1, terminal current Io flows through the OVP diode 372.

Each respective power generator module can include a temperature sensor circuit. The control circuit 320-1 overrides a command to activate the switch 350-1 (i.e., the control circuit 320-1 turns OFF the switch 350-1) in response to detecting that a temperature associated with the respective power generator module is above a threshold value.

The control circuit 320-1 reconnects the power source 340 in series in the string (by activating the switch 350-1 again) when the temperature falls below a predetermined threshold or module voltage, Vpv, (such as an output voltage prodded by a respective power source 340) rises again above a predetermined threshold. Reconnection or reactivation of the respective power generator module in the series can be further controlled by a time delay and some nominal threshold hysteresis to prevent rapid FET switch 350-1 or relay switch oscillation. Thus, each respective power generator module can includes a voltage level sensor circuitry to control the switch 350-1 to an OFF state in response to detecting that a voltage produced by the voltage regulator circuit to power the respective power generator module is below an under-voltage threshold value.

In view of the embodiments as discussed herein, the magnitude of current through a respective string of power generator modules can decrease in response to any of one or more of the following conditions: shorting output voltage 260 of the string; terminating generation of the control signal 240-S; disabling the remote signal generator (such as control signal generator 240) in response to a fault condition; opening of the switch 350; physically disconnecting a power generator module from the string; and opening a fuse device or circuit breaker disposed between the power generator module and the load 230.

Individual signal generators can be attached to each string to disconnect individual strings if each string is isolated by an individual inverter, optimizer, or charger. Also, it is well known that the field-effect transistor (FET) such as an N-type field effect transistor or switch 350-1 in FIGS. 8 and 9 can be replaced by another type of transistor, e.g., a bipolar-junction transistor (BJT) or insulated-gate-bipolar transistor (IGBT), and may be either enhancement mode or depletion mode.

In addition, any of the apparatus or methods described by FIGS. 7, 8, and 9 may also be combined with other functions such as optimizers which adjust DC-to-DC conversion such that each string operates at its maximum power point, or micro-inverters which adjust DC-to-AC conversion such that each module operates at its maximum power point. The apparatus can also be combined with arc fault detectors attached to each photovoltaic module. Also remote arc fault or ground fault detectors combined with remote power-line disconnect or shorting switches can be used with the apparatus or methods described herein. In addition, while simple analog circuit hardware is preferred, other hardware such as microcontrollers or ASICs (application specific integrated circuits) can be used instead to implement the basic control described herein augmented by more sophisticated signal processing.

FIG. 10 shows an example graph 1000 of PV module current vs. module voltage for three levels of uniform irradiance. The absolute module impedance |Z| varies as a function of operating point, where Z is the incremental impedance at the operating point.

### Optional Latch Type Embodiments

According to further possible embodiments, there is provided a control apparatus attached to each photovoltaic power module, comprising a switch in series with a respective module and control circuit with output terminals that interconnect a string of power modules and an array of such strings. An external load such as an inverter or charger is connected to the output of said string or array. Disconnection of each module by shorting the output of said string or array and reconnection by externally raising the DC voltage of said output are enabled by said series switch and control circuit. This embodiment defines a method using output terminal voltage to latch said series switch and an internal load resistance in the required states.

In another aspect of the present invention, there is provided an apparatus attached to each photovoltaic power module, comprising a series switch and control circuit and output terminals, that interconnect a string of power modules and an array of such strings. An external load such as an inverter or charger is connected to the output of said string or array. Disconnection of each module by opening the output of said string or array and reconnection by externally raising the DC voltage of said output are enabled by said series switch and control circuit. This embodiment defines a method using output terminal current and voltage to latch said series switch and an internal load resistance in the required states.

As discussed below, the latch type PV modules can be pulsed with a current to latch the respective PV module to an ON state. The PV modules as discussed below can be used as substitutes to the power generator modules as discussed above. The PV modules discussed below are a specific type of power generator module that become latched based on receipt of a current pulse signal from a remote source such as a control signal generator 240.

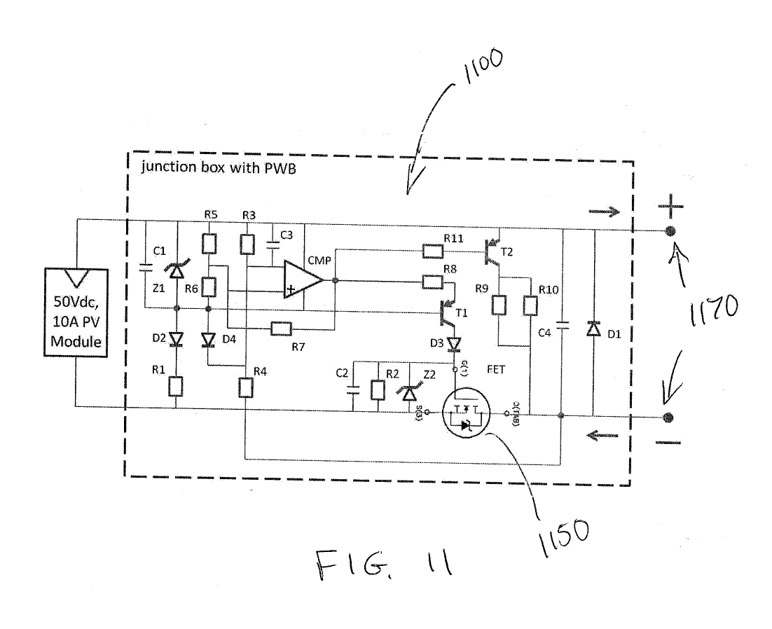

Now, more particularly, FIG. 11 is an example diagram illustrating a PV module combined with a FET switch and control circuit, electrically connected to output terminals according to embodiments herein.

Control circuit 1100 provides flexibility to predetermine terminal voltage thresholds to close and open switch 1150. The control circuit 1100 latches the FET switch 1150 closed and open. If the output terminals 1170 become electrically separated from an external power source or load, a state of the FET switch 1150 does not change state.

For example, if the FET switch 1150 is closed, the respective PV module voltage keeps the FET switch 1150 closed (i.e., ON) if the output terminals 1170 are electrically separated from an external power source, and if the FET switch 1150 is open (i.e., OFF), the predetermined internal load keeps the voltage across the output terminals low and therefore the FET switch 1150 open if the output terminals 1170 are electrically separated from an external load, e.g., if the shorting switch opens (i.e., OFF) or if there is a disconnection in the power wires between said shorting switch and output terminals.

Providing more schematic detail, capacitor C4 helps protect the FET switch 1150 and control circuit 1100 against ESD (electro-static discharge) and helps filter high frequency noise between the positive and negative output terminals 1170. When the FET (i.e., switch 1150) is open, the FET substrate diode (i.e., inherent diode in the FET) and the PV module limit the voltage across bypass diode D1 and control circuit when an external power source, e.g., other PV strings, increases the voltage across the output terminals, and bypass diode D1 and the PV module limit the voltage across the FET and control circuit when an external power source, e.g., other PV modules in the same string, decreases the voltage across the output terminals. Capacitor C2, resistor R2, and zener diode Z2 are attached to the gate of FET switch to control the switch response time, turn-off the FET in the absence of external gate drive, and protect the gate from over-voltage.

Power for the control circuit is provided by the PV module through a voltage regulator composed of capacitor C1, zener diode Z1, diode D2 and resistor R1; diode D2 prevents discharge of C1 through R1 when the output terminals are shorted together and FET switch is closed. The voltage across the output terminals are sensed by comparator CMP and components R4, R3, C3, and along with R5, R6, and R7, these components determine the two voltage thresholds which determine when the comparator switches; C3 provides a time delay between when the terminal voltage crosses one of these thresholds and the comparator output switches. Diode D4 prevents the inverting input voltage of the comparator from being below a diode drop below than the comparator's lower power supply rail. Components R8, T1, and D3 comprise the gate drive circuit connecting the comparator output and the FET gate; T1 converts CMP output voltage to FET gate drive current and serves as a level shifter between the CMP circuit which is referenced to the positive PV module connection and the FET circuit which is referenced to the negative PV module connection; D3 prevents voltage across voltage regulator capacitor C1 from discharging through the base-collector junction of T1 and the zener Z2 when the output terminal voltage falls below the voltage across C1.

Components R11, T2, R9, and R10 provide a special function not found in solid-state relays, namely an internal load is applied across output terminals when the voltage across said terminals is below a first predetermined threshold, and the load is removed when said voltage is above a second predetermined threshold. This function serves to keep the FET open by keeping the output terminal voltage below a first predetermined threshold if the output terminals are electrically separated from an external load, and to decrease the internal power dissipation by removing the internal load if the output terminal voltage is above a second predetermined threshold.

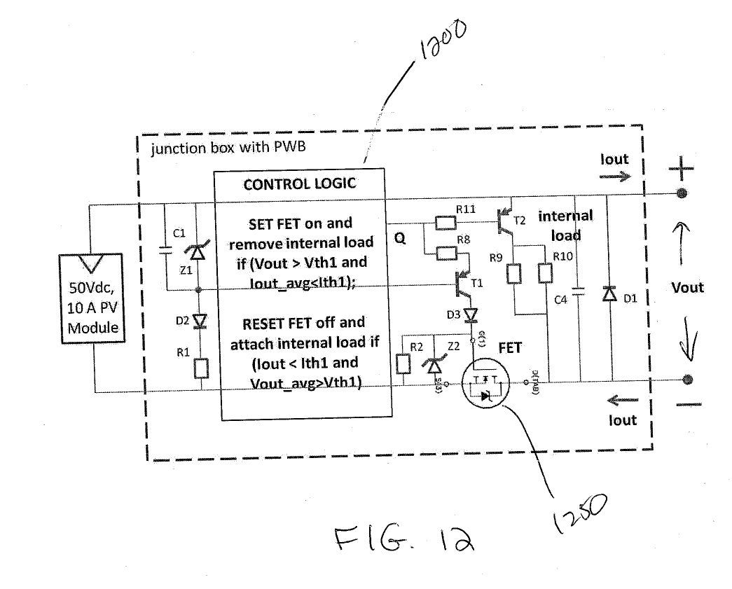

FIG. 12 further illustrates a PV module combined with a FET switch and control circuit, electrically connected to output terminals according to embodiments herein.

As shown in this figure, the control circuit provides an S-R latch function with output Q. The control circuit 1200 latches the FET switch 1250 open (i.e., turns it OFF) and reconnects an internal load if the output current Tout falls below a first predetermined current threshold (i.e., the terminals become electrically separated from an external load) while the time-averaged output voltage has been above a first predetermined voltage threshold. The control circuit 1200 latches the FET switch closed (i.e., turns it ON) and disconnects an internal load if the output voltage Vout rises above a second predetermined voltage threshold (i.e., caused by an external power source) while the time-averaged output current has been below a second predetermined current threshold.

The use of time-averaged current and voltage parameters prevents S-R latch from being set or reset for the wrong reasons, e.g., when Tout is below a predetermined threshold because Vout is low, or when Vout is above a predetermined threshold under normal operation when Tout is high.

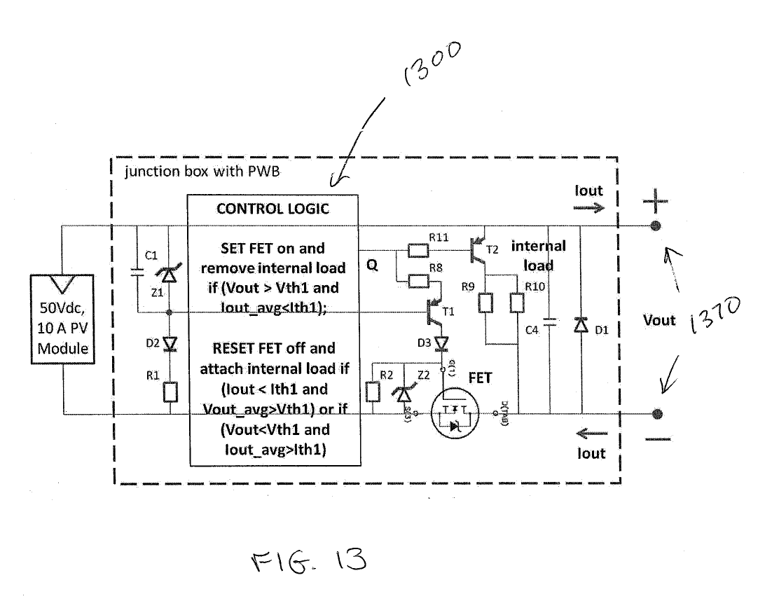

FIG. 13 is an example diagram illustrating a PV module combined with a FET switch and control circuit, electrically connected to output terminals according to embodiments herein.

As shown, the control circuit 1300 provides an S-R latch function with output Q that combines two remote disconnect methods (remote shorting switch or remote DC disconnect). This figure describes the control logic in control circuit 1300. The control circuit 1300 can include Iout and voltage Vout sensing circuits to monitor Iout and Vout, respectively.

In this example embodiment, the control logic disconnects the module from output terminals 1370 if a remote switch shorts the power lines together or interrupts power line current. Reconnection may be inhibited by an internal load until a remote power source increases the power line voltage. Note that the control logic references the time average of Iout and Vout as well as the instantaneous value of these variables to implement the disconnect and reconnect methods described herein.

Note that embodiments herein can further include circuits known as optimizers, which adjust the DC-to-DC conversion such that each module operates at its maximum power point, or DC-to-AC converters, and more particularly circuits that are known as micro-inverters which adjust the DC-to-AC conversion such that each module operates at its maximum power point.

Embodiments herein can also be combined with transient type fault detectors attached to each photovoltaic module. Also remote arc fault or ground fault detectors combined with the remote disconnect or shorting switches and the remote reconnect power supply can be used with the apparatus or methods described herein.

In addition, while simple control logic hardware can be used, other hardware such as microcontrollers or ASICs (application specific integrated circuits) can be used instead to implement the basic control logic described herein augmented by more sophisticated signal processing.

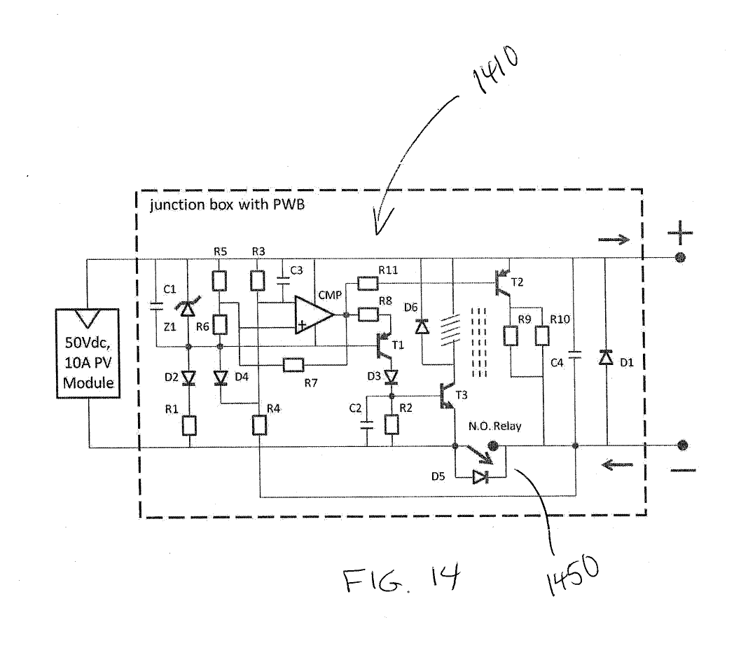

FIG. 14 is an example diagram illustrating a PV module combined with a normally-open relay switch 1450 and control circuit 1410, electrically connected to output terminals according to embodiments herein.

Control circuit 1410 provides flexibility to predetermine terminal voltage thresholds to close and open switch 1450. The control circuit 1410 latches the relay closed and open. If the output terminals become electrically separated from an external power source or load, the state of switch 1450 does not change because it is latched.

For example, as shown, the electromechanical relay version of said apparatus with a normally-open relay switch 1450 replacing the FET as previously discussed. Transistor T3 drives relay coil. Diode D6 prevents excessive voltage from appearing across T3, and diode D5 along with the PV panel prevents excessive voltage from appearing across positive and negative output terminals.

Note again that techniques herein are well suited for use in any type of power system. However, it should be noted that embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A power system comprising:
a string of power generator modules, the power generator modules in the string controllably connected in series to convey power produced by the power generator modules over a power line through the power generator modules to a load, each of the respective power generator modules including:
a sensing element to monitor presence of a control signal received by the respective power generator module on the power line from a remote signal generator;
a switch to selectively connect the respective power generator module in the series connection; and
a controller that controls a state of the switch based on the control signal received over the power line.

2. The power system as in claim 1, wherein the power generator modules are PhotoVoltaic (PV) modules that convert solar energy to electrical energy; and
wherein each of the power generator modules in the string includes an anode and cathode serially connected in the power line.

3. The power system as in claim 1, wherein the control signal is an AC signal generated by the remote signal generator; and
wherein each of the power generator modules includes a capacitor disposed across output terminals of the respective power generator module to convey the control signal on the power line.

4. The power system as in claim 1, wherein the controller sets the switch to an OFF state to operate the respective power generator module in a bypass mode in the absence of detecting presence of the control signal.

5. The power system as in claim 1, wherein the sensing element is a current sensing element to detect the control signal;
wherein the controller activates the switch to an ON state responsive to detecting that the current sensed by the current sensing element is greater than a first threshold value; and
wherein the controller deactivates the switch to an OFF responsive to detecting that the current sensed by the current sensing element is less than a second threshold value.

6. The power system as in claim 5, wherein first threshold value and the second threshold value are substantially equal.

7. The power system as in claim 1 further comprising:
a diode disposed across output terminals of the respective power generator module to protect the switch from being damaged by an over voltage condition.

8. The power system as in claim 7, wherein the diode serves as a bypass diode when the switch is set to an OFF state, enabling over-temperature and under-voltage control to limit power dissipation of control circuitry in the respective power generator module without shutting off string current.

9. The power system as in claim 1, wherein the sensing element is a transformer device that detects presence of current injected onto the power line by the remote signal generator.

10. The power system as in claim 1, wherein a current through the string decreases in response to at least one condition from the group consisting of:
shorting output voltage of the string;
terminating generation of the control signal;
disabling the remote signal generator in response to a fault condition;
opening of the power line disconnect switch;
physically disconnecting a power generator module from the string; and
opening a fuse device or circuit breaker disposed between the power generator module and the load.

11. The power system as in claim 1, wherein the controller and related control circuitry in the respective power generator module is powered via power generated by a power source in the respective power generator module.

12. The power system as in claim 1, wherein the switch is a transistor.

13. The power system as in claim 1, wherein the switch is an electromechanical relay device.

14. The power system as in claim 2, wherein the respective power generator module includes a temperature sensor circuit, the controller turning OFF the switch in response to detecting that a temperature associated with the respective power generator module is above a threshold value.

15. The power system as in claim 2, wherein the respective power generator module includes a voltage level sensor to control the switch to an OFF state in response to detecting that a voltage produced by the respective power generator module is below an under-voltage threshold value.

16. The power system as in claim 10, wherein occurrence of a parallel arc across an array in the respective power generator module reduces an array voltage and thereby disconnects modules from the output array and reduces the power that can be delivered to a fault.

17. The power system as in claim 1, wherein the remote signal generator produces the control signal as a keep-alive signal.

18. A method comprising:
generating a control signal;
transmitting the control signal over a power line to activate each of multiple power generator modules in a series connection of multiple power generator modules; and
receiving power over the power line from the activated power generator modules connected in series.

19. The method as in claim 18, wherein generating the control signal includes generating the control signal as an AC signal over the power line; and
wherein receiving the power over the power line includes receiving a substantially DC voltage produced by the series connection of activated power generator modules to power a load.

20. The method as in claim 18 further comprising:
discontinuing transmission of the control signal over the power line to deactivate each respective power generator module in the series connection of multiple power generator modules.

21. The method as in claim 18, wherein transmitting the control signal over the power line causes substantially simultaneous activation of the power generator modules to produce an output voltage.

22. A power generator module disposed in a series connection of multiple power generator modules, a respective power generator module in the series connection comprising:
an anode power terminal;
a cathode power terminal;
a diode device, an anode of the diode device coupled via an electrical path to the cathode power terminal of the respective power generator module, a cathode of the diode device coupled via an electrical path to the anode power terminal of the power generator module.

23. The power generator module as in claim 22 further comprising:
a switch disposed in series with a power source in the respective power generator module that generates power, the switch controlling application of the power produced by the power source across the anode power terminal and the cathode power terminal of the respective power generator module.

24. The power generator module as in claim 23, wherein the switch is a field effect transistor having an inherent diode, a forward bias of the inherent diode supporting a current flow from the anode power terminal to the cathode power terminal through the power source.

25. The power generator module as in claim 24, wherein a combination of the switch disposed in series with the power resource is disposed substantially in parallel with the diode device.

26. The power generator module as in claim 23 further comprising:
a sensor element to monitor a communication signal received over a power line to which the anode power terminal and cathode power terminal are connected; and
control circuitry to control a state of the switch depending on the communication signal.
